(19) United States
(12) Patent Application Publication
(10) Pub. No.: US 2008/0251363 A1
(43) Pub. Date: Oct. 16, 2008

(54) MANUAL INPUT DEVICE

(76) Inventor: Mikio Onodera, Miyagi-ken (JP)

Correspondence Address: BRINKS HOFER GILSON & LIONE, P.O. BOX 10395, CHICAGO, IL, 60610, US

(21) Appl. No.: 12/054,606

(22) Filed: Mar. 25, 2008

(30) Foreign Application Priority Data
Apr. 11, 2007 (JP) 2007-103875

(51) Int. Cl. H01H 19/00

(52) U.S. Cl. 200/336

(57) ABSTRACT

An elevating member is fitted on a rotary shaft of a rotation operating member slidably supported by a base so that it can be elevated, first and second cam members are provided in the rotation operating member, and first and second elastic contact members are provided so as to be elevated. By forming guide grooves, which extend in an oblique direction, in the elevating member, and slidably inserting engaging projections provided in the base into the guide grooves, the sliding operating force on the rotation operating member in a horizontal direction is converted into the elevation operating force of the elevating member in a vertical direction, and the first and second elastic contact members are selectively engaged with any one of the first and second cam members according to the elevated position of the elevating member.

This application claims benefit of Japanese Patent Application No. 2007-103875 filed on Apr. 11, 2007, which is hereby incorporated in its entirety by reference.

### BACKGROUND

1. Field of the Invention

The present invention relates to a manual input device that controls various electronic apparatuses as an operator operates to rotate a rotation operating member, and particularly, relates to a manual input device with an operation feeling imparting function capable of imparting a plurality of kinds of brake pedal feelings to the rotation operating member.

2. Description of the Related Art

In a vehicle-mounted controller having a plurality of kinds of electronic apparatuses, such as an air conditioner, an audio system, and a car navigator, a manual input device is known in which selection or control of functions of the electronic apparatuses is collected in one rotation operating member, and an operator operates to rotate the rotation operating member, thereby performing selection of an apparatus, control of a function, and the like. Generally, such a manual input device is provided with an operation feeling imparting means that imparts a required operating force or a required click feeling to a rotation operating member in order to improve the brake pedal feeling of the rotation operating member to ensure an operation.

As a conventional example of such an operation feeling imparting means, a configuration has been suggested in which a plurality of cam members is secured to a rotary shaft of a rotation operating member in a stacked state, an elastic contact member that is movable in the direction of the rotary shaft of the rotation operating member is disposed at a side of each of the cam members, and the elastic contact member is moved up and down using an electric actuator as a driving source, thereby switching the engagement relationship between each of the cam members and the elastic contact member to generate a plurality of kinds of click feelings (for example, reference is made to Japanese Unexamined Patent Application Publication No. 2002-189559).

Further, as another conventional example of the operation feeling imparting means, a configuration has been suggested in which a plurality of cam members is secured to a rotary shaft of a rotation operating member in a stacked state, a plurality of sets of elastic contact members and momentary switches corresponding to the cam members, respectively, are disposed, and an arbitrary momentary switch is pressed to engage one elastic contact member with a corresponding cam member, thereby switching the engagement relationship between each of the cam members and each of the elastic contact members to generate a plurality of kinds of click feelings (for example, reference is made to Japanese Unexamined Patent Application Publication No. 2006-222003).

Meanwhile, in the former conventional example disclosed in Japanese Unexamined Patent Application Publication No. 2002-189559, one elastic contact member is selectively engaged with the plurality of cam members using an electric actuator. Therefore, the whole device is not made large by the operation feeliny imparting means, but an expensive electric actuator is needed as a driving source of the elastic contact member. Thus, there is a problem in that the cost may increase. On the other hand, in the latter conventional example disclosed in Japanese Unexamined Patent Application Publication No. 2006-222003, the engagement relationship between the elastic contact members and the cam members is mechanically switched according to the pressing operating force of the momentary switches. Therefore, the electric actuator that increases costs can be omitted. However, it is necessary to dispose the plurality of momentary switches corresponding to the cam members, respectively. This becomes a major factor that increases the size of the whole device.

### SUMMARY

A manual input device includes a rotation operating member capable of being operated to rotate and operated to move in a lateral direction crossing the direction of a rotary shaft; and an operation feeling imparting mechanism that imparts a rotational operation feeling to the rotation operating member. The manual input device further includes: an elevating member supported so as to be elevated in a longitudinal direction along the direction of the rotary shaft, and a force converting mechanism that converts the moving operation of the rotation operating member into the elevating operation of the elevating member, and elevates the elevating member to different elevated positions according to the movement position of the rotation operating member. Here, the operation feeling imparting mechanism is interposed between the rotation operating member and the elevating member to impart different operation feelings to the rotation operating member according to the elevated position of the elevating member.

In the manual input device configured in this way, when an operator operates to slide or operates to rock the rotation operating member, the moving operation of the rotation operating member is converted into the elevating operation of the elevating member by the force converting mechanism. This imparts different operation feelings to the rotation operating member from the operation feeling imparting means according to the elevated position of the elevating member. Therefore, it is possible to miniaturize the whole device while a mechanical means is used as a drive mechanism of the operation feeling imparting means.

In the manual input device disclosed herein, the moving operation force on the rotation operating member by an operator is converted into the elevating operation of the elevating member by the force converting mechanism, so that different operation feelings can be imparted to the rotation operating member from the operation feeling imparting means according to the elevated position of the elevating member. Therefore, it is possible to miniaturize the whole device while a mechanical means is used as a drive mechanism of the operation feeling imparting means.

### BRIEF DESCRIPTION OF THE DRAWINGS

FIG. 1 is a plan view of a manual input device according to a first embodiment;

FIG. 2 is a sectional view taken along the line II-II of FIG. 1;

FIG. 3 is a sectional view taken along the line III-III of FIG. 2;

FIG. 4 is a sectional view taken along the line IV-IV of FIG. 3;

FIG. 5 is a sectional view taken along the line V-V of FIG. 2;

FIG. 6 is a sectional view showing a state where a rotation operating member of FIG. 2 is slidingly operated; and

FIG. 7 is a view showing the schematic configuration of a manual input device according to a second embodiment.

### DESCRIPTION OF THE EMBODIMENTS

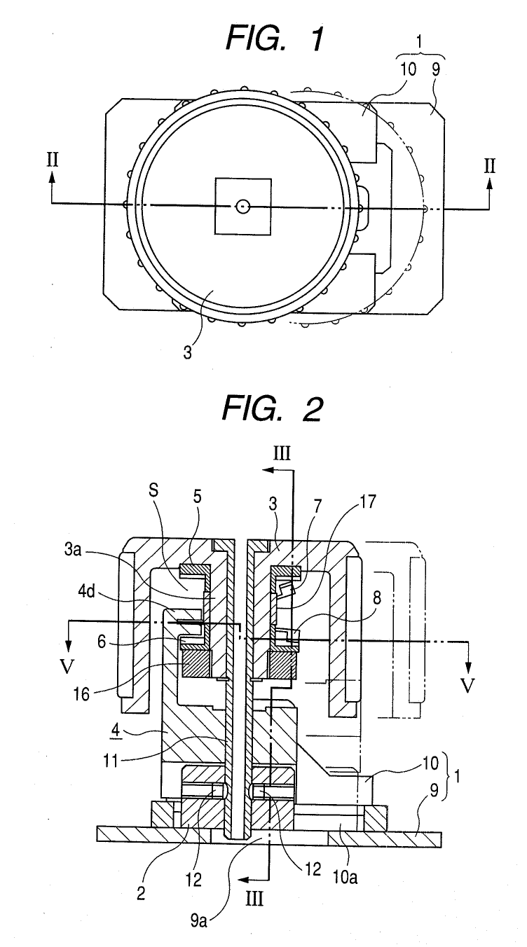

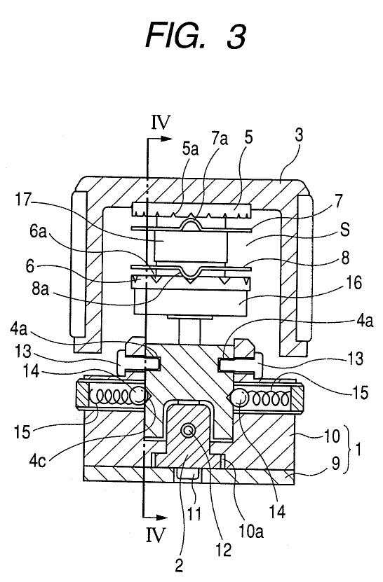

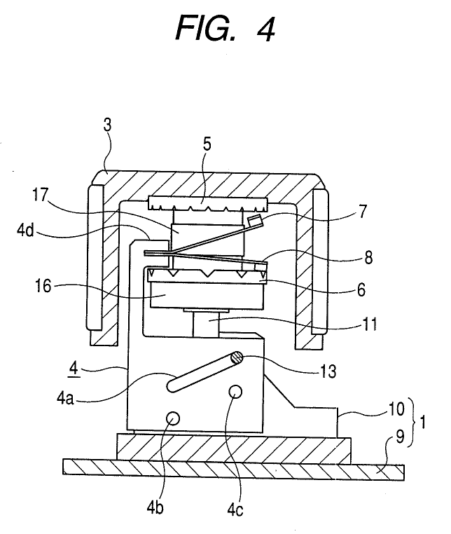

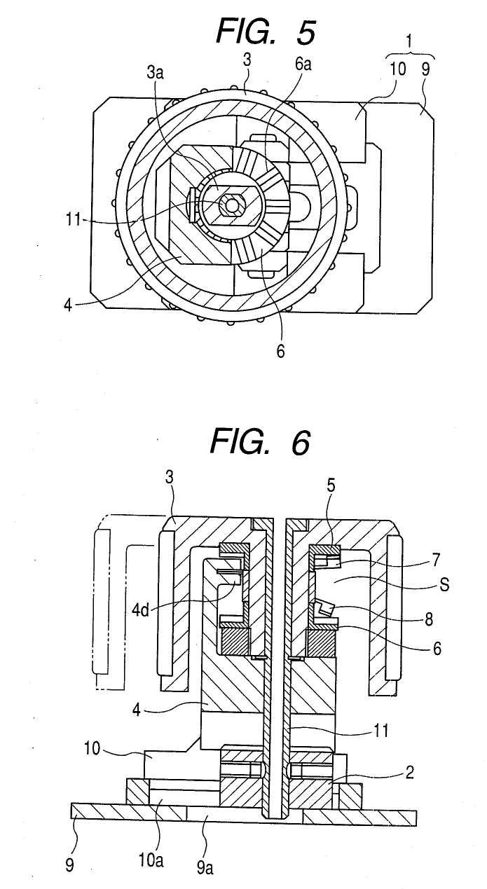

Embodiments of the invention will be explained with reference to the drawings in that FIG. 1 is a plan view of a manual input device according to a first embodiment, FIG. 2 is a sectional view taken along the line II-II of FIG. 1, FIG. 3 is a sectional view taken along the line III-III of FIG. 2, FIG. 4 is a sectional view taken along the line IV-IV of FIG. 3, and FIG. 5 is a sectional view taken along the line V-V of FIG. 2, and FIG. 6 is a sectional view showing a state where a rotation operating member of FIG. 2 is slidingly operated.

The manual input device according to this embodiment includes a base 1 that is fixed on an installation parent material in a vehicle room, such as a center console, a sliding member 2 that is reciprocally supported in a horizontal direction by the base 1, a rotation operating member 3 that is rotatably supported by the sliding member 2, an elevating member 4 that is supported by the rotation operating member 3 so as to be elevated in a vertical direction, first and second cam members 5 and 6 that are anchored to the rotation operating member 3, and first and second elastic contact members 7 and 8 that are held by the elevating member 4, and the first and second cam members 5 and 6 and the first and second elastic contact members 7 and 8 constitutes an operation feeling imparting mechanism.

The base 1 is composed of a substrate 9 having an opening 9a, and a guide member 10 fixed on the substrate 9. The guide member 10 is formed with a guide groove 10a that extends in the horizontal direction, and the sliding member 2 is guided by the guide groove 10a to move in the horizontal direction between a first position shown in FIG. 2, and a second position shown in FIG. 6. A tubular portion 3a is suspended from a middle portion of an inner surface of the rotation operating member 3, and a rotary shaft 11 is anchored to the tubular portion 3a. A lower end of the rotary shaft 11 is inserted through the sliding member 2, and reaches the opening 9a of the substrate 9, and a slip-out preventing pin 12 prevents the rotary shaft 11 from slipping out of the sliding member 2. This enables the rotation operating member 3 to rotate about the rotary shaft 11 with respect to the sliding member 2, and enables the rotation operating member 3 and enables the sliding member 2 to move integrally between the first position and the second position. In addition, although now shown, a rotation detecting sensor, such as a rotary encoder or rotary volume, is connected to the rotary shaft 11. Thus, when an operator operates the rotation of the rotation operating member 3, the rotational amount and rotational direction thereof is detected from the rotation detecting sensor. Further, a pair of detection switches that is operated by the movement of the sliding member 2 is mounted on the substrate 9, and whether the sliding member 2 is located in the first position or the second position is detected by the detection switches.

The elevating member 4 is fitted on the rotary shaft 11 so that it can be elevated in the vertical direction between the tubular portion 3a of the rotation operating member 3, and the sliding member 2. As shown in FIGS. 3 and 4, guide grooves 4a that extend in an oblique direction is formed in both side surfaces of the elevating member 4, and distal ends of engaging projections 13 fixed to the guide member 10 are slidably inserted into the guide grooves 4a. The guide grooves 4a and the engaging projections 13 constitute a force converting mechanism, and the force that slidingly operates the rotation operating member 3 in the horizontal direction is converted into the force that operates to elevate the elevating member 4 by the force converting mechanism. That is, when the rotation operating member 3 is in the first position shown in FIG. 2, the elevating members 4 are held in a lowered position where upper ends of the guide grooves 4a engage the engaging projections 13 (refer to FIG. 4). However, since the relative position of the guide grooves 4a and the engaging projections 13 changes while the rotation operating member 3 slidingly moves from the first position to the right of FIG. 2. Therefore, when the rotation operating member 3 moves to the second position shown in FIG. 6, the elevating member 4 is held in a raised position where lower ends of the guide grooves 4a engage the engaging projections 13.

Further, first holding holes 4b and second holding holes 4c are formed in both side surfaces of the elevating member 4, and steel balls 14 that are able to engage and disengage the holding holes 4b and 4c are held in the guide member 10 under the resilient force of the springs 15. The first holding holes 4b are formed in the vicinity of the lower ends of the guide grooves 4a, and as the steel balls 14 engage the first holding holes 4b, the elevating member 4 can be stably held in the lowered position. On the other hand, the second holding holes 4c are formed in the vicinity of the upper ends of the guide grooves 4a, and as the steel balls 14 engage the second holding holes 4c, the elevating member 4 can be stably held even in the raised position.

The first cam member 5 and the second cam member 6 are fixed to the tubular portion 3a of the rotation operating member 3 using a nut 16. Between the first and second cam members 5 and 6 is interposed a spacer 17 that keeps the spacing therebetween constant. A plurality of click grooves 5a are formed at predetermined intervals in a peripheral direction in a bottom face of the first cam member 5, and a plurality of click grooves 6a are formed at predetermined intervals in the peripheral direction in a top face of the second cam member 6. It is noted herein that the array pitch and groove depth of both the click grooves 5a and 6a are changed. In this embodiment, the click grooves 5a of a narrow pitch are formed as shallow grooves in the first cam member 5, and the click grooves 6a of a broad pitch are formed as deep grooves in the second cam member 6.

The elevating member 4 has a holding portion 4d at its upper end, and the holding portion 4d protrudes into a spatial portion S defined between the first cam member 5 and the second cam member 6. The first elastic contact member 7 and the second elastic contact member 8 are obtained by forming elastic thin plates, such as phosphor bronze or stainless steel, in a ring shape, and the first and second elastic contact members 7 and 8 are attached to the holding portion 4d of the elevating member 4. The first elastic contact member 7 is formed with an upward salient portion 7a, and the salient portion 7a faces the click grooves 5a of the first cam member 5. The second elastic contact member 8 is formed with a downward salient portion 8a, and the salient portion 8a faces the click grooves 6a of the second cam member 6. The first and second elastic contact members 7 and 8 move up and down inside the spatial portion S with the elevating operation of the elevating member 4, and when the elevating member 4 is held in the lowered position in the first position as shown in FIG. 2, the salient portion 8a of the second elastic contact member 8 is brought into pressure contact with the second cam member 6, but the salient-portion 7a of the first elastic contact member 7 is separated from the first cam member 5. Accordingly, when an operator operates to rotate the rotation operating member 3 in the first position, a click grooves 6a of the second cam member 6 that rotate integrally with the rotation operating member 3 is disengaged from the salient portion 8a of the second elastic contact member 8, thereby generating a click feeling, and the click feeling is fed back to the operator via the rotation operating member 3. On the other hand, when the elevating member 4 is held in the raised position in the second position as shown in FIG. 6, the salient portion 7a of the first elastic contact member 7 is brought into pressure contact with the first cam member 5, but the salient portion 8a of the second elastic contact member 8 is separated from the second cam member 6. Accordingly, when an operator operates to rotate the rotation operating member 3 in the second position, a click groove 5a of the first cam member 5 that rotate integrally with the rotation operating member 3 is disengaged from the salient portion 7a of the first elastic contact member 7, thereby generating a click feeling, and the click feeling is fed back to the operator via the rotation operating member 3.

In the manual input device configured in this way, when the rotation operating member 3 is in the first position shown in FIG. 2, the elevating member 4 is in the lowered position where the upper ends of the guide grooves 4a engage the engaging projections 13, and as the steel balls 14 engage the first holding holes 4b, the elevating member 4 is stably held in the lowered position. Further, the sliding member 2 turns on one of the pair of detection switches that are not shown, and on this ON signal, a unique function assigned to the first position, for example, the function of controlling the air volume of an air-conditioner, is selected. Also, when the operator operates to rotate the rotation operating member 3 in the first position, the rotation detecting sensor connected to the rotary shaft 11 of the rotation operating member 3 is operated. Therefore, for example, the air volume control of an air-conditioner is performed on the basis of a detection signal of the rotation detecting sensor. Then, since the elevating member 4 is held in the lowered position, and the salient portion 8a of the second elastic contact member 8 is brought into pressure contact with the second cam member 6, a click grooves 6a of the second cam member 6 is disengaged from the salient portion 8a of the second elastic contact member 8, thereby generating a click feeling, and the click feeling is fed back to the operator via the rotation operating member 3.

When the rotation operating member 3 slidingly moves to the right of FIG. 2 from this state, the sliding operating force is converted into the raising force of the elevating member 4 by the force converting mechanism composed of the guide grooves 4a and the engaging projections 13. Therefore, with the sliding operation of the rotation operating member 3, the elevating member 4 is lowered in the axial direction of the rotary shaft 11. Also, when the rotation operating member 3 is in the second position shown in FIG. 6, the elevating member 4 moves to the raised position where the lower ends of the guide grooves 4a engage the engaging projections 13, and as the steel balls 14 engage the second holding holes 4c, the elevating member is stably held in the lowered position. Further, as the elevating member 4 moves to the raised position, the salient portion 8a of the second elastic contact member 8 is separated from the second cam member 5, and instead, the salient portion 7a of the first elastic contact member 7 is brought into pressure contact with the first cam member 5. Moreover, since the sliding member 2 also moves slidingly to the right along with the rotation operating member 3, the sliding member 2 is separated from one detection switch, to turn on the other detection switch, and on the basis of the ON signal, a unique function assigned to the second position, for example, the function of con-trolling the temperature of an air-conditioner, is selected. Also, when an operator operates to rotate the rotation operating member 3 in this second position, the temperature control of an air-conditioner is performed on the basis of a detection signal of the rotation detecting sensor connected to the rotary shaft 11 of the rotation operating member 3. Then, since the elevating member 4 is held in the raised position, and the salient portion 7a of the first elastic contact member 7 is brought into pressure contact with the first cam member 5, a click groove 5a of the first cam member 5 is disengaged from the salient portion 7a of the first elastic contact member 7, thereby generating a click feeling, and the click feeling is fed back to the operator via the rotation operating member 3.

Further, when the rotation operating member 3 in the second position slidingly moves to the left of FIG. 6, the operation reverse to the above operation is performed. In this case, since the sliding operating force of the rotation operating member 3 to the left is converted into the lowering force of the elevating member 4 by the guide grooves 4a and the engaging projections 13 (force converting mechanism), the salient portion 7a of the first elastic contact member 7 is separated from the first cam member 5, and instead, the salient portion 8a of the second elastic contact member 8 is brought into pressure contact with the second cam member 6.

In the manual input device according to this embodiment, the sliding operating force on the rotation operating member 3 in the horizontal direction by an operator is converted into the elevation operating force of the elevating member 4 in the vertical direction by the force converting mechanism composed of the guide grooves 4a and the engaging projections 13. Since this enables the first and second elastic contact members 7 and 8 to selectively engage the first and second cam members 5 and 6 according to the elevated position of the elevating member 3, thereby imparting different operation feelings to the rotation operating member 3. Therefore, it is possible to miniaturize the whole device using a mechanical means as a drive mechanism of the operation feeling imparting mechanism (the first and second cam members 5 and 6 and the first and second elastic contact members 7 and 8).

In addition, the array pitch or groove depth of the click grooves 5a and 6a that are formed in the first and second cam members 5 and 6 are not limited to the above embodiment, and can be changed suitably. Similarly, the spring characteristics of the first and second elastic contact members 7 and 8, the shapes of the salient portions 7a and 8a, or the like can be changed suitably. Further, in the above embodiment, the first and second cam members 5 and 6 are provided on the side of the rotation operating member 3, and the first and second elastic contact members 7 and 8 are provided on the side of the elevating member 3. However, in contrast to this, the first and second elastic contact members 7 and 8 can be provided on the side of the rotation operating member 3, and the first and second cam members 5 and 6 can be provided on the side of the elevating member 3. Otherwise, the first cam member 5 and the second elastic contact member 8 may be provided on the side of the rotation operating member 3, the first elastic contact member 7 and the second cam member 6 may be provided on the side of the elevating member 3.

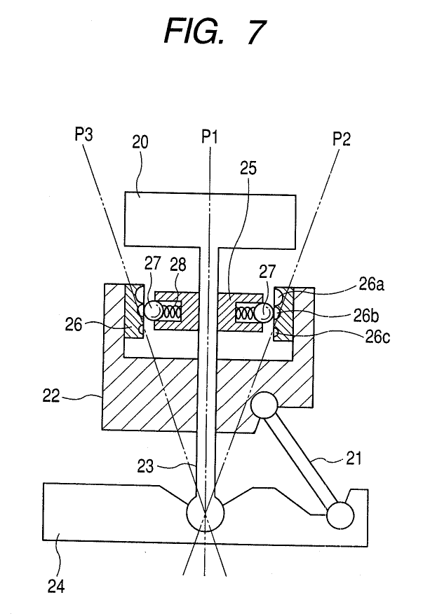

FIG. 7 is a view showing the schematic configuration of a manual input device according to a second embodiment. In this manual input device, the rocking operating force on the rotation operating member 20 is converted into the elevation operating force of the elevating member 22 in the vertical direction by a force converting mechanism composed of a rocking arm 21. This point is largely different from the aforementioned first embodiment.

That is, a lower end of a rotary shaft 23 that is suspended from a middle portion of a bottom face of the rotation operating member 20 is pivotally coupled with a base 24, and the rotation operating member 20 is rotatably and rockably supported by the base 24. A driving receiving member 25 is anchored to the rotary shaft 23 of the rotation operating member 20, and the driving receiving member 25 rotates integrally with the rotary shaft 23. Further, the elevating member 22 is slidably and non-rotatably fitted on the rotary shaft 23, and both ends of a rocking arm 21 are rotatably connected to the elevating member 22 and the base 24. A cylindrical cam member 26 is anchored to the elevating member 22, and first to third click grooves 26a, 26b, and 26c are formed in an inner peripheral surface of the cam member 26. The click grooves 26a, 26b, and 26c are distributed in the vertical direction, and their array pitch and groove depth differ from one another. In this embodiment, the first click grooves 26a are formed as deepest grooves at a broad pitch, and the third click grooves 26c are formed as shallowest grooves at a narrow pitch. A pair of steel balls 27 are held so as to protrude into or retreat from the driving receiving member 25, and the steel balls 27 are brought into pressure contact with an inner peripheral surface of the cam member 26 under the resilient force of a spring 28. Also, the steel balls 27 and the spring 28 that are held by the click grooves 26a, 26b, and 26c formed in the cam member 26, and the driving receiving member 25 constitutes an operation feeling imparting means. In addition, although not shown, a rotation detecting sensor that detects the rotational amount or rotational direction of the rotation operating member 20 is connected to the rotary shaft 23, and three detection switches that detect the rocking angle of the rotation operating member 20 are connected to the rocking arm 21.

In the manual input device configured in this way, the rotation operating member 20 can be operated to rock between three positions denoted by P1, P2, and P3 of FIG. 7, and can be operated to rotate the rotation operating member 20 can be operated to rotate in each of the positions. FIG. 7 shows that the rotation operating member 20 is in the first position P1. In this case, the steel balls 27 engage the second click grooves 26b at a middle stage of the cam member 26. Thus, when the rotation operating member 20 is operated to rotate in the first position P1, the steel balls 27 are disengaged from the second click grooves 26b, thereby generating a click feeling. Further, when the rotation operating member 20 is operated to rock from the first position P1 to the second position P2, the rocking operating force is converted into the raising force of the elevating member 22 by the rocking arm 21. Thus, the engagement relationship between the steel balls 27 and the cam member 26 shifts to the third click grooves 26c at a lowermost stage of the cam member. Accordingly, when the rotation operating member 20 is operated to rotate in the second position P2, the steel balls 27 are disengaged from the third click grooves 26c, thereby generating another click feeling. On the other hand, when the rotation operating member 20 is operated to rock from the first position P1 to the third position P3, the rocking operating force is converted into the lowering force of the elevating member 22 by the rocking arm 21. Thus, the engagement relationship between the steel balls 27 and the cam member 26 shifts to the first click grooves 26a at an uppermost stage of the cam member. Accordingly, when the rotation operating member 20 is operated to rotate in the third position P3, the steel balls 27 are disengaged from the first click grooves 26a, thereby generating another click feeling.

In addition, in the above-described first and second embodiments, a cam member that comes into elastic contact with an elastic contact member is switched to impart different operation feelings. However, the invention is not limited thereto. For example, one cam member that comes into elastic contact with an elastic contact member may be provided, and the elastic contact force on the cam member is changed according to the elevated position of the elastic contact member so as to impart different operation feelings.

1. A manual input device comprising:
a rotation operating member capable of being operated to rotate and operated to move in a lateral direction crossing the direction of a rotary shaft; and
an operation feeling imparting mechanism that imparts a rotational operation feeling to the rotation operating member,
an elevating member supported so as to be elevated in a longitudinal direction along the direction of the rotary shaft, and
a force converting mechanism that converts the moving operation of the rotation operating member into the elevating operation of the elevating member, and elevates the elevating member to different elevated positions according to the movement position of the rotation operating member,
wherein the operation feeling imparting mechanism is interposed between the rotation operating member and the elevating member to impart different operation feelings to the rotation operating member according to the elevated position of the elevating member.

2. The manual input device according to claim 1,
wherein the operation feeling imparting mechanism is composed of a plurality of cam portions that are provided in one of the rotation operating member and the elevating member, and elastic contact members provided in the other of the rotation operating member and the elevating member, and the elastic contact members are selectively engaged with one of the cam portions according to the elevated position of the elevating member.

3. The manual input device according to claim 2,
wherein each of the cam portions is composed of a first cam portion and a second cam portion that are provided in the rotation operating member, and a spatial portion extends in the direction of the rotary shaft of the rotation operating member is defined between the first cam portion and the second cam portion, and the elastic contact members provided in the elevating member operate to be elevated inside the spatial portion.

4. The manual input device according to claim 1,
wherein the rotary shaft of the rotation operating member is inserted through the elevating member, a base that movably supports the elevating member is included, and a force converting mechanism is interposed between the elevating member and the base.

5. The manual input device according to claim 4,
wherein the force converting mechanism is composed of a guide groove provided in one of the elevating member and the base, and a projection provided in the other of the elevating member and the base and slidably inserted into the guide groove, and the guide groove extends in an oblique direction with respect to the rotary shaft of the rotation operating member.
